(19) United States
(12) Patent Application Publication
(10) Pub. No.: US 2025/0341226 A1
(43) Pub. Date: Nov. 6, 2025

(54) PUMP PROPORTIONAL CONTROL WITH INPUT SIGNAL MODIFICATION

(71) Applicant: Oshkosh Corporation, Oshkosh, WI (US)

(72) Inventors: John Wolf, Oshkosh, WI (US); Ryan Bishop, Oshkosh, WI (US); Cole Koenigs, Oshkosh, WI (US); Chris Rukas, Oshkosh, WI (US)

(73) Assignee: Oshkosh Corporation, Oshkosh, WI (US)

(21) Appl. No.: 19/197,812

(22) Filed: May 2, 2025

Related U.S. Application Data
(60) Provisional application No. 63/642,178, filed on May 3, 2024.

(51) Int. Cl. F15B 19/00; B65F 3/02; B65F 3/04

(52) U.S. Cl. CPC F15B 19/00; B65F 3/04; B65F 2003/0269; B65F 2003/0283; F15B 2211/50

(57) ABSTRACT

A refuse vehicle can include a first element, a hydraulic system, and one or more processing circuits. The one or more processing circuits can receive a first input to control the first element to cause the first element to perform a first operation of the refuse vehicle, obtain first information to indicate a metric associated with an energy source of the hydraulic system, determine that a first amount of fluid power exceeds a fluid power threshold for the hydraulic system, and modify the first input to reduce a request from the first amount of fluid power to a second amount of fluid power.

### CROSS-REFERENCE TO RELATED PATENT APPLICATIONS

This application claims the benefit of and priority to U.S. Provisional Patent Application No. 63/642,178, filed on May 3, 2024, the entirety of which is incorporated by reference herein.

### BACKGROUND

Refuse vehicles can include hydraulic systems to provide power to components of the refuse vehicles. For example, hydraulic systems can provide fluid power.

### SUMMARY

At least one embodiment relates to a refuse vehicle. The refuse vehicle can include a first element. The first element can perform a first operation of the refuse vehicle. The refuse vehicle can include a second element. The second element can perform a second operation of the refuse vehicle. The refuse vehicle can include a hydraulic system. The hydraulic system can power the first element and the second element. The refuse vehicle can include a device. The device can receive inputs to control operation of the first element and the second element. The refuse vehicle can include a control system. The control system can communicate with the hydraulic system and the device. The control system can include one or more memory devices. The one or more memory devices can store instructions thereon. The instructions can, when executed by one or more processors, cause the one or more processors to receive, responsive to a first interaction with the device, a first input to control the first element to cause the first element to perform the first operation of the refuse vehicle. The first input can indicate a request for a first amount of fluid power from the hydraulic system. The instructions can cause the one or more processors to obtain, via one or more sensors of the refuse vehicle, information to indicate a metric associated with an energy source of the hydraulic system. The instructions can cause the one or more processors to determine, based on the information and a status of the second element, that the first amount of fluid power exceeds a fluid power threshold for the hydraulic system. The instructions can cause the one or more processors to modify, responsive to determination that the first amount of fluid power exceeds the fluid power threshold, the first input to reduce the request from the first amount of fluid power to a second amount of fluid power below the fluid power threshold.

At least one embodiment relates to a refuse vehicle. The refuse vehicle can include a first element. The first element can perform a first operation of the refuse vehicle. The refuse vehicle can include a second element. The second element can perform a second operation of the refuse vehicle. The refuse vehicle can include a hydraulic system. The hydraulic system can power the first element and the second element. The refuse vehicle can include a device. The device can receive inputs to control operation of the first element and the second element. The refuse vehicle can include a control system. The control system can communicate with the hydraulic system and the device. The control system can include one or more memory devices. The one or more memory devices can store instructions thereon. The instructions can, when executed by one or more processors, cause the one or more processors to receive, responsive to a first interaction with the device, a first input to control the first element to cause the first element to perform the first operation of the refuse vehicle. The first input can indicate a request for a first amount of fluid power from the hydraulic system. The instructions can cause the one or more processors to obtain, via one or more sensors of the refuse vehicle, information to indicate a metric associated with an energy source of the hydraulic system. The instructions can cause the one or more processors to determine, based on the information and a status of the second element, that the first amount of fluid power exceeds a fluid power threshold for the hydraulic system. The instructions can cause the one or more processors to modify, responsive to determination that the first amount of fluid power exceeds the fluid power threshold, the first input by decreasing a power level associated with the first input from a first level to a second level to reduce the request from the first amount of fluid power to a second amount of fluid power below the fluid power threshold. The instructions can cause the one or more processors to transmit, to the hydraulic system, one or more signals having the second level of the power level to cause the hydraulic system to provide the second amount of fluid power to the first element.

At least one embodiment relates to a system. The system can include one or more memory devices. The one or more memory devices can store instructions thereon. The instructions can, when executed by one or more processors, cause the one or more processors to receive, responsive to a first interaction with a device of a refuse vehicle, a first input to control a first element of the refuse vehicle to cause the first element to perform a first operation of the refuse vehicle. The first input can indicate a request for a first amount of fluid power from a hydraulic system of the refuse vehicle. The instructions can cause the one or more processors to obtain, via one or more sensors of the refuse vehicle, information to indicate a metric associated with an energy source of the hydraulic system. The instructions can cause the one or more processors to determine, based on the information and a status of a second element of the refuse vehicle, that the first amount of fluid power exceeds a fluid power threshold for the hydraulic system. The instructions can cause the one or more processors to modify the first input to reduce the request from the first amount of fluid power to a second amount of fluid power.

At least one embodiment relates to a system. The system can include one or more memory devices. The one or more memory devices can store instructions thereon. The instructions can, when executed by one or more processors, cause the one or more processors to receive, responsive to a first interaction with a device of a refuse vehicle, a first input to control a first element of the refuse vehicle to cause the first element to perform a first operation of the refuse vehicle. The first input can indicate a request for a first amount of fluid power from a hydraulic system of the refuse vehicle. The instructions can cause the one or more processors to obtain, via one or more sensors of the refuse vehicle, information to indicate a metric associated with an energy source of the hydraulic system. The instructions can cause the one or more processors to determine, based on the information and a status of a second element of the refuse vehicle, that the first amount of fluid power exceeds a fluid power threshold for the hydraulic system. The instructions can cause the one or more processors to modify the first input to adjust a power level of the first input from a first level to a second level to reduce the request from the first amount of fluid power to a second amount of fluid power.

At least one embodiment is directed to a refuse vehicle. The refuse vehicle can include at least one element. The at least one element can perform one or more operations of the refuse vehicle. The refuse vehicle can include a power system. The power system can provide power to the at least one element. The refuse vehicle can include a device. The device can receive inputs to control operation of the at least one element. The refuse vehicle can include one or more processing circuits. The one or more processing circuits can receive, responsive to a first interaction with the device, a first input to control the at least one element. The first input can indicate a request for a first amount of power from the power system. The one or more processing circuits can determine that the first amount of power exceeds a power threshold for the power system. The one or more processing circuits can modify, responsive to determination that the first amount of power exceeds the power threshold, the first input to reduce the request from the first amount of power to a second amount of power below.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of a front-loading refuse vehicle, according to an exemplary embodiment.

FIG. 2 is a perspective view of a side-loading refuse vehicle, according to an exemplary embodiment.

FIG. 3 is a perspective view of a zero-radius side-loading refuse vehicle, according to an exemplary embodiment.

FIG. 4 is a perspective view of a body of the refuse vehicle of FIG. 3, according to an exemplary embodiment.

FIG. 5 is a block diagram of a system to provide input signal modification, according to an exemplary embodiment.

FIG. 6 is a sequence diagram illustrating communications between one or more components included in the system illustrated in FIG. 5, according to an exemplary embodiment.

FIG. 7 is a block diagram of a logic path including logic blocks to provide input signal modification, according to an exemplary embodiment.

FIG. 8 is a graph illustrating relationships between joystick interactions and component movement of a refuse vehicle, according to an exemplary embodiment.

FIG. 9 is a perspective view of a joystick, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, systems and methods to provide pump proportional control by input signal modification are described herein. For example, a controller and/or processing circuit may modify control signals (e.g., input signals) to adjust an amount of power (e.g., fluid power, hydraulic power, electrical current, electric signals, etc.) that is provided to components of a refuse vehicle to provide pump proportional control to the components of the refuse vehicle. Pump proportional control by input signal modification may refer to and/or include adjusting, modifying, reducing, decreasing, and/or otherwise changing values and/or levels for various signals to maintain a relationship (e.g., proportionality) between a movement of a component and an interaction by an operator of the refuse vehicle.

Various components of the refuse vehicle may receive fluid power to control movement and/or operations of the components. In some instances, the refuse vehicle and/or a hydraulic system thereof may have limited fluid power to provide to the components. For example, a hydraulic system may have a max flow rate of hydraulic fluid. As another example, the hydraulic system may be able to provide fluid power up to a given amount (e.g., gallons per minute, pressure per square inch, etc.). In either example, complications may arise when the request for fluid power by the components of the refuse vehicle exceeds the maximum amount of fluid power for which the hydraulic system can provide.

Other refuse vehicles may include and/or implement compensation valves to adjust various fluid power amounts. For example, a hydraulic system may include a compensation valve so that the hydraulic system only provides a given amount of fluid power even when a control signal requests and/or indicates a larger amount of fluid power. Stated otherwise, the fluid power output of the hydraulic system is fixed and/or maintained regardless of the initial power request associated with the control signals. However, the implementation of compensation valves results in additional cost given the inclusion of additional parts. Furthermore, proportional control of the components is lost when fixed fluid power is implemented. For example, an operator of the refuse vehicle may interact with a device (e.g., a joystick, a button, a control mechanism, etc.) to cause a grab arm to perform a given action. In this example, the operator may perform a given interaction to cause the hydraulic system to provide a given amount of fluid power. However, in this example, when the given amount of fluid power exceeds the fixed value, proportional control is lost as the operator input and the corresponding movement of the grab arm are not proportional (e.g., the movement of the grab arm is not based on the given amount of fluid power indicated by the given interaction).

As another example, an operator of a refuse vehicle may interact with a joystick of the refuse vehicle to cause a lift arm and/or lifting apparatus to move. To continue this example, the operator may move the joystick relative to a rest point. As the joystick moves further from the rest point the movement and/or action of the lift arm may increase (e.g., the lift arm moves faster, extends faster, etc.). The hydraulic system may increase and/or adjust an amount of fluid power that is provided to the lift arm to cause the movement of the lift arm to increase. In instances when the amount of fluid power requested exceeds the maximum amount available, pump proportional control may be lost as the hydraulic system is unable to provide an amount of fluid power that corresponds to the user interaction.

Some technical solutions described herein include modifying and/or adjusting input signals (e.g., signals generated and/or based on operator interactions) to provide pump proportional control. For example, a processing circuit may receive an input signal that calls for a first amount of fluid power. To continue this example, the processing circuit may modify the input signal to adjust (e.g., decrease, changed, alter, etc.) the input signal from a first level (e.g., a first voltage level, a first current level, a first power level, etc.) to a second level (e.g., a second voltage level, a second current level, a second power level, etc.). As another example, a change from a first position to a second position of a joystick may be associated with increasing a speed of a movement of lift arm by a given amount (e.g., the increase in speed is proportional to movement of the joystick). In this example, the processing circuit may modify and/or decrease levels of input signals to maintain proportionality even when maximum fluid power is reached.

Referring to FIGS. 1-3, a vehicle (e.g., a refuse truck, a garbage truck, a waste collection truck, a sanitation truck, etc.), shown as refuse vehicle 10, includes a support structure (e.g., a frame or chassis), shown as frame 12, and a structural body or storage device, shown as body 14. The body 14 may be of various shapes, sizes, and configurations to accommodate different styles and variations of the refuse vehicle 10. The body 14 may have two generally lateral sides running substantially parallel from a front end of the body 14 to a back end of the body 14 (e.g., relative to a primary direction of travel of the refuse vehicle 10, etc.). The frame 12 is fixedly coupled to an occupancy compartment, shown as cab 18.

As shown in FIGS. 1-3, the cab 18 is coupled to a front end of the frame 12. The cab 18 includes various components to facilitate operation of the refuse vehicle 10 by an operator (e.g., a seat, a steering wheel, hydraulic controls, etc.). In one embodiment, the refuse vehicle 10 further includes a prime mover or primary driver, shown as engine 20, coupled to the frame 12 at a position beneath the cab 18. The engine 20 provides power to a plurality of motive members or tractive elements, shown as wheels 22, and to other systems of the vehicle (e.g., a pneumatic system, a hydraulic system, etc.). The engine 20 may be configured to utilize a variety of fuels (e.g., gasoline, diesel, biodiesel, ethanol, natural gas, etc.), according to various exemplary embodiments. According to an alternative embodiment, the engine 20 is replaced by or accompanied by one or more electric motors (e.g., in a hybrid configuration, in a pure electric configuration, etc.). The electric motors may consume electrical power from an on-board storage device (e.g., batteries, ultra-capacitors, etc.), from an on-board generator (e.g., an internal combustion engine, a thermoelectric generator, etc.), and/or from an external power source (e.g., overhead power lines, electromagnetic radiation, etc.) and provide power to the systems of the refuse vehicle 10.

According to an exemplary embodiment, the refuse vehicle 10 is configured to transport refuse from various waste receptacles within a municipality to a storage facility and/or a processing facility (e.g., a landfill, an incineration facility, a recycling facility, etc.). As shown in FIGS. 1-3, the body 14 includes panels 24, a tailgate 26, and a cover 28. The panels 24, the tailgate 26, and the cover 28 define a chamber that includes a collection chamber, shown as hopper portion 30, and a storage chamber, shown as storage portion 32. Loose refuse is placed into the hopper portion 30 and is thereafter compacted into the storage portion 32. The hopper portion 30 and the storage portion 32 provide temporary storage for refuse during transport to a waste disposal site and/or a recycling facility. In some embodiments, at least a portion of the body 14 extends in front of the cab 18. According to the embodiments shown in FIGS. 1-3, the body 14 is positioned behind the cab 18. According to an exemplary embodiment, the hopper portion 30 is positioned between the storage portion 32 and the cab 18 (i.e., refuse is initially loaded into a position behind the cab 18 and stored in a position further toward the rear of the refuse vehicle 10).

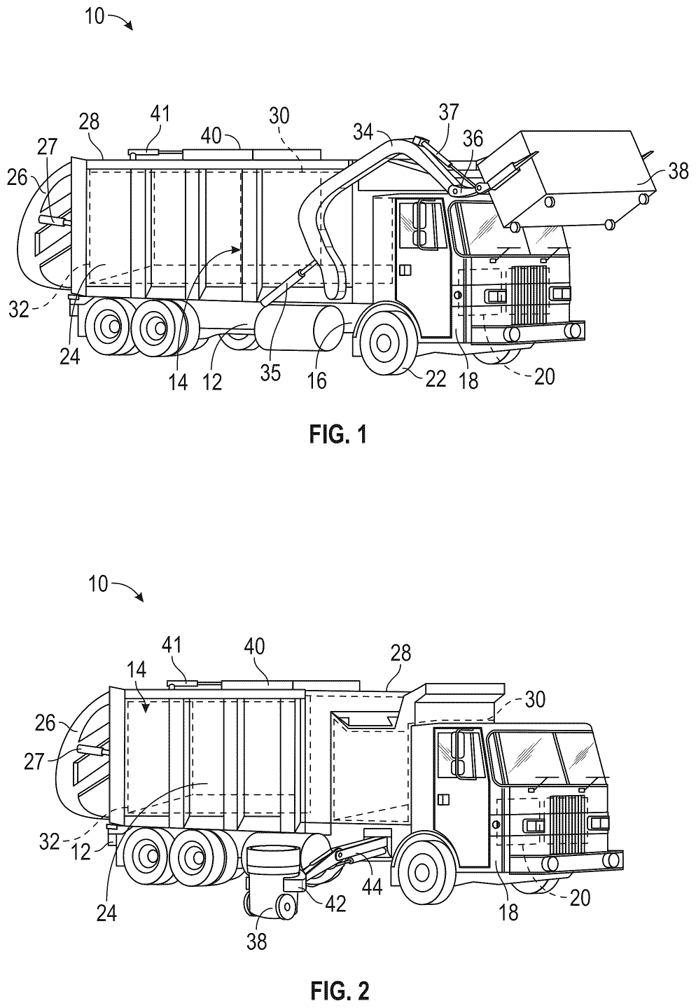

The tailgate 26 is pivotally coupled to the panels 24 such that the tailgate 26 is rotatable relative to the frame 12 about a lateral axis. A pair of actuators (e.g., hydraulic cylinders, pneumatic cylinders, linear actuators, etc.), shown as tailgate actuators 27, are coupled to the tailgate 26 and the panels 24. The tailgate actuators 27 are configured to selectively reposition the tailgate 26 between a lowered, packing, or closed position, shown in FIGS. 1 and 2, and a raised, emptying, or open position. In the closed position, the tailgate 26 extends across an opening defined by the panels 24, preventing refuse from exiting the body 14. In the open position, this opening is uncovered, permitting refuse to be evacuated from the body 14.

Referring again to the exemplary embodiment shown in FIG. 1, the refuse vehicle 10 is a front-loading refuse vehicle. As shown in FIG. 1, the refuse vehicle 10 includes manipulators, shown as a pair of arms 34, coupled to the frame 12 on either side of the cab 18. The arms 34 may be rotatably coupled to the frame 12 with a pivot (e.g., a lug, a shaft, etc.). A pair of lifting actuators (e.g., hydraulic cylinders, pneumatic cylinders, linear actuators, etc.), shown as arm lifting actuators 35, are coupled to the frame 12 and the arms 34, and extension of the arm lifting actuators 35 rotates the arms 34 about a lateral axis extending through the pivot.

According to an exemplary embodiment, interface members or a container handling system, shown as forks 36, are coupled to the arms 34. The forks 36 may have a generally rectangular cross-sectional shape and are configured to engage a container, shown as the refuse container 38, (e.g., protrude through apertures within the refuse container 38, etc.). The forks 36 are pivotally coupled to the arms 34 such that forks 36 rotate relative to the arms 34 about a lateral axis to adjust an orientation of the refuse container 38. A pair of actuators (e.g., hydraulic cylinders, pneumatic cylinders, linear actuators, etc.), shown as fork actuators 37, are coupled to the arms 34 and the forks 36, and extension or retraction of the fork actuators 37 rotates the forks 36 about the lateral axis to control the orientation of the refuse container 38.

The refuse container 38 may be rectangular (e.g., an industrial refuse container, a commercial refuse container, a residential refuse container, a trash can, etc.), cylindrical (e.g., a residential refuse container, refuse bin, refuse can, a trash can, a ninety-six galleon refuse container, etc.), prismatic, or of any other shape for the storage of refuse, and may be thereby tailored for a target application. During operation of the refuse vehicle 10, the forks 36 are positioned to engage the refuse container 38 (e.g., the refuse vehicle 10 is driven into position until the forks 36 protrude through the apertures within the refuse container 38). As shown in FIG. 1, the arms 34 are rotated to lift the refuse container 38 over the cab 18. The fork actuators 37 articulate the forks 36 to tip the refuse out of the refuse container 38 and into hopper portion 30 through an opening in cover 28. The arm lifting actuators 35 and the fork actuators 37 thereafter rotate the arms 34 and the forks 36 to return the empty the refuse container 38 to the ground.

According to an exemplary embodiment, a top door 40 is slidably coupled to the body 14. An actuator (e.g., a hydraulic cylinder, a pneumatic cylinder, a linear actuator, etc.), shown as top door actuator 41, is coupled to the body 14 and the top door 40. The top door actuator 41 is configured to move the top door 40 longitudinally along a top surface of the body 14 (e.g., the cover 28) between an open or loading position and a closed, sealing, or driving position. In the loading position, the top door 40 is moved away from the opening to the hopper portion 30, permitting refuse to be added to the hopper portion 30. In the driving position, the top door 40 seals the opening, thereby preventing refuse from escaping the refuse vehicle 10 (e.g., due to wind, inertia, etc.).

Referring to the exemplary embodiment shown in FIG. 2, the refuse vehicle 10 is a side-loading refuse vehicle that includes a container handling system or manipulator, shown as grabber 42, configured to interface with (e.g., engage, wrap around, selectively couple to, etc.) the refuse container 38. According to the exemplary embodiment shown in FIG. 2, the grabber 42 is movably coupled to the body 14 with an arm 44. Together, the grabber 42 and the arm 44 may form a grabber assembly. The arm 44 includes a first end coupled to the body 14 and a second end coupled to the grabber 42. One or more actuators (e.g., hydraulic cylinders, pneumatic cylinders, linear actuators, etc.) articulate the arm 44 and position the grabber 42 to interface with the refuse container 38. The arm 44 may be moveable in one or more directions (e.g., up and down, left and right, in and out, rotation, etc.) to facilitate positioning the portion of the grabber 42 to interface with the refuse container 38.

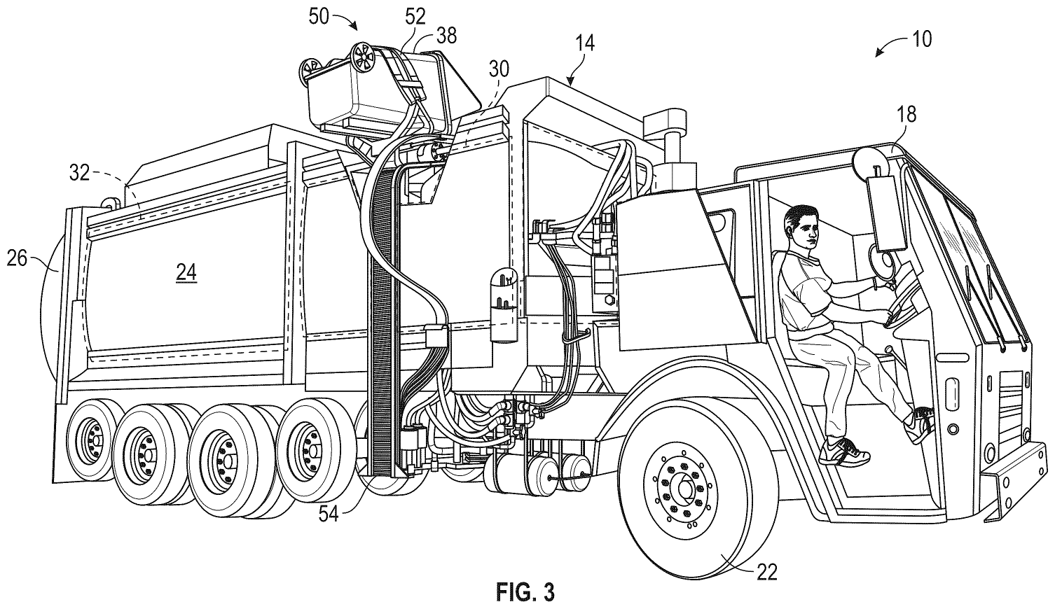

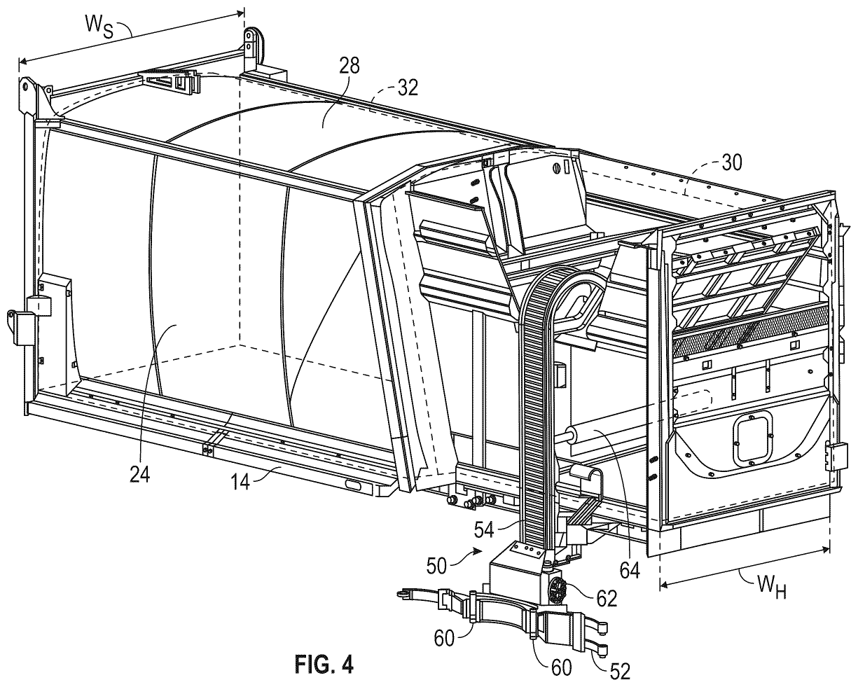

Referring to the exemplary embodiment shown in FIGS. 3-4, the refuse vehicle 10 is a zero-radius (e.g., ZR, etc.) side-loading refuse vehicle that includes a container handling system, shown as grabber assembly 50. The grabber assembly 50 includes a manipulator, shown as grabber 52, movably coupled to the body 14 with guide, shown as a track 54. The grabber 52 is opened and/or closed (e.g., to engage or release the refuse container 38) by one or more actuators (e.g., hydraulic cylinders, pneumatic cylinders, hydraulic motors, pneumatic motors, linear actuators, rotary actuators, etc.), shown as grabber actuators 60. The grabber 52 is moved along a length of the track by one or more actuators (e.g., hydraulic cylinders, pneumatic cylinders, hydraulic motors, pneumatic motors, linear actuators, rotary actuators, etc.), shown as grabber lift actuator 62. The grabber lift actuators 62 are coupled to the grabber 52 and the track 54. The grabber 52 and the track 54 are translatably coupled to the body 14 (e.g., by a telescoping assembly). An actuator (e.g., hydraulic cylinders, pneumatic cylinders, linear actuators, etc.), shown as grabber extend actuator 64, is coupled to the track 54 and the body 14. The grabber extend actuator 64 is configured to extend and retract to move the grabber 52 and the track 54 laterally relative to the body 14. By way of example, the grabber extend actuator 64 may be extended to move the grabber 52 and the track 54 laterally outward from the body 14 to reach a refuse container 38 that is positioned a distance away from the body 14. As shown in FIG. 4, the body 14 includes a width W_{H} of the hopper portion 30 and a width W_{S} of the storage portion 30. Side-loading refuse vehicles such as that shown in FIGS. 3-4, the width W_{H} of the hopper portion 30 may be less than the width W_{S} of the storage portion 32 to accommodate the grabber assembly 50 without increasing an overall width of the refuse vehicle 10.

In operation, an operator drives the refuse vehicle 10 into position such that the grabber assembly 50 is longitudinally aligned with a refuse container 38. The grabber extend actuator 64 is then extended until the grabber 52 is proximate (e.g., in contact with, spaced a short distance from, etc.) the refuse container 38. The grabber actuator 60 is activated to close the grabber 52 on the refuse container 38. After interfacing with the refuse container 38, the grabber extend actuator 64 is retracted, and the grabber lift actuator 62 is activated to elevate the grabber 52 along the track 54. The track 54 may include a curved portion at an upper portion of the body 14 such that grabber 52 and the refuse container 38 are automatically tipped toward the hopper portion 30 of the refuse vehicle 10 when the grabber 52 reaches a predetermined position along the length of the track 54. As the grabber 52 is tipped, refuse falls through an opening defined by the cover 28 and into the hopper portion 30 of the refuse vehicle 10. The grabber lift actuator 62 and the grabber extend actuator 64 then return the empty refuse container 38 to its original position, and the grabber actuators 60 may release the refuse container 38. The top door 40 may be returned to the driving position to seal the opening, thereby preventing refuse from escaping the body 14 (e.g., due to wind, inertia, etc.).

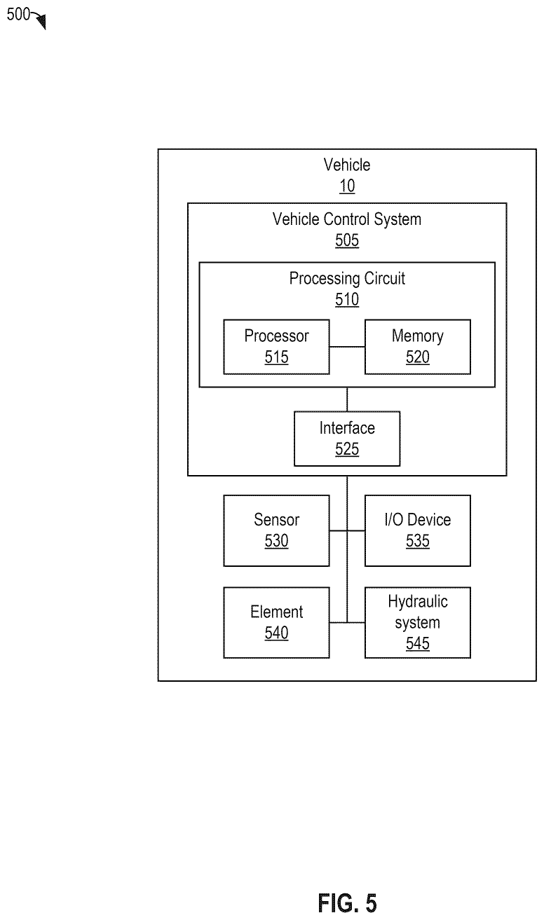

FIG. 5 depicts a block diagram of a system 500, according to an exemplary embodiment. In some embodiments, the system 500 can include the vehicle 10. The vehicle 10 may refer to and/or include at least one of the various vehicles described herein. For example, the vehicle 10 may include a refuse vehicle. In some embodiments, the vehicle 10 may include at least one vehicle control system 505, at least one sensor 530, at least one Input/Output (Shown as I/O device 535), at least one element 540, and at least one hydraulic system 545. For example, the vehicle control system 505 may be integrated with the vehicle 10.

In some embodiments, the various components and/or devices of the vehicle 10 may be coupled with one another. For example, the hydraulic system 545 may be fluidly coupled with the element 540 such that the hydraulic system 545 can provide power (e.g., fluid power) to the element 540. The various components in the system 500 can be implemented via hardware (e.g., circuitry), software (e.g., executable code), or any combination thereof. For example, the vehicle control system 505 may include computing devices or execution units that are housed on Printed Circuit Boards (PCBs). Systems, devices, and components in FIG. 5 can be added, deleted, integrated, separated, and/or rearranged.

In some embodiments, the sensors 530 may include at least one of a position sensor, an accelerometer, a tachometer, a speedometer, a GPS device/sensor, a temperature sensor, a voltmeter, an ammeter, a radar sensor, a pressure sensor, a tactile sensor, a photodetector, a motion sensor, a proximity sensor, a telemetry device, and/or among other possible sensors and/or devices. For example, the sensors 530 can include a position sensor that can collect data to determine a position and/or an orientation of the vehicle 10. In other embodiments, the sensors 530 may include cameras, video devices, audio devices, haptic devices, optical devices, and/or other possible optical instruments can capture, record, produce and/or otherwise provide videos and/or images. The cameras can also include audio devices. For example, the cameras can include at least one of a speaker, a microphone, a headphone, and/or among other possible audio and/or sound devices.

In some embodiments, the sensors 530 may be placed, located, situated, positioned, coupled, and/or otherwise disposed on various components and/or locations on the vehicle 10. In some embodiments, the sensors 530 may collect the various types of data and/or information described herein. For example, the sensors 530 may collect telemetry data, diagnostics data, vehicle operation data, and/or data inputs. In some embodiments, the telemetry data may include data relating to the operation of the vehicle 10 such as, system statuses, a status of various vehicle subsystems and components (e.g., engine, transmission, tire pressure, brakes, pump(s), etc.), vehicle status (e.g., if a door is open, if equipment is deployed, etc.), and/or implement actions.

In some embodiments, the I/O devices 535 may be or include a steering wheel, a joystick, buttons, switches, knobs, levers, an accelerator pedal, a brake pedal, etc. In some embodiments, the I/O devices 535 may include at least one of a screen, a monitor, a visual display device, a touchscreen display, a television, a video display, a light emitting diode (LED) display, Liquid Crystal Display (LCD), a mobile device, a kiosk, a digital terminal, a mobile computing device, a desktop computer, a smartphone, a tablet, a smart watch, a smart sensor, and/or any other device that can facilitate providing, receiving, displaying and/or otherwise interacting with content (e.g., webpages, mobile applications, etc.). For example, the I/O devices 535 may include displays that include a resistive touchscreen that can receive user input via interactions (e.g., touches) with the touchscreen.

In some embodiments, the I/O devices 535 may receive at least one input. For example, I/O device 535 may include a joystick and the I/O device 535 may receive an input responsive to movement (e.g., interaction) of the joystick by an operator of the vehicle 10. In some embodiments, the I/O devices 535 may receive inputs to control operation of the elements 540. For example, the I/O devices 535 may receive a first input to cause a lift arm (e.g., an element 540) to raise a waste receptacle towards the vehicle 10. In some embodiments, movement of the I/O devices 535 may cause various control signals to be transmitted to the hydraulic system 545 causing the hydraulic system 545 to provide fluid power to the elements 540. In other embodiments, the hydraulic system 545 may provide other types of power, such as electrical power, hydraulic power, air pressure, etc. For example, the hydraulic system 545 may include one or more power systems to provide electrical current to one or more electric actuators to cause the electric actuators to move.

In some embodiments, the elements 540 may be or include at least one of the various components and/or systems of the vehicle 10 described herein. For example, the elements 540 may include the arms 34. As another example, the elements 540 may include the tailgate actuators 27. As even another example, the elements 540 may include one or more movable and/or translatable components of the vehicle 10. In some embodiments, the elements 540 may perform at least one operation of the vehicle 10. For example, the arms 34 (e.g., a first element 540) may lift and/or move a refuse container (e.g., a first operation). As another example, the grabber 52 (e.g., a second element 540) may grab the refuse container (e.g., a second operation). In some embodiments, operations of the vehicle 10 may refer to and/or include the elements 540 performing one or more actions and/or movements as described herein.

In some embodiments, the hydraulic system 545 may be or include pumps, gauges, hoses, cords, fluid storage devices, etc. to provide and/or control fluid power to the elements 540. For example, the hydraulic system 545 may be fluidly coupled with the elements 540 and the hydraulic system 545 may provide fluid power to move or otherwise control the elements 540. As another example, the hydraulic system 545 may provide fluid power to the arm lifting actuators 35 to cause extension of the arm lifting actuators 35 to rotate the arms 34.

In some embodiments, the vehicle control system 505 may include at least one processing circuit 510 and at least one interface 525. The vehicle control system 505 may be communicably coupled with at least one or more component of the system 500 via the interface 525. For example, the vehicle control system 505 may be communicably coupled, via the interface 525, with the hydraulic system 545 such that the vehicle control system 505 may transmit one or more control signals to the hydraulic system 545. In some embodiments, the processing circuit 510 may include at least one processor 515 and memory 520.

In some embodiments, the processing circuits 510 and/or one or more components thereof (e.g., the processors 515 and memory 520) may perform similar functionality to that of the vehicle control system 505 and/or one or more components thereof. For example, memory 520 may store programming logic that, when executed by the processors 515, causes the processors 515 to control various amounts of fluid power provided by the hydraulic system 545. In some embodiments, the processors 515 may be implemented as a general-purpose processor, an application specific integrated circuit (ASIC), one or more field programmable gate arrays (FPGAs), a group of processing components, or other suitable electronic processing components.

In some embodiments, memory 520 (e.g., memory, memory unit, storage device, etc.) may include one or more devices (e.g., RAM, ROM, Flash memory, hard disk storage, etc.) for storing data, computer code, or executable instructions for completing or facilitating the various processes, layers, and modules described herein. Memory 520 may be or include volatile memory or non-volatile memory. Memory 520 may include database components, object code components, script components, or any other type of information structure for supporting the various activities and information structures described in the present application. According to an exemplary embodiment, memory 520 is communicably connected to the processors 515 via the processing circuits 510 and memory 520 includes computer code for executing (e.g., by the processing circuits 510 and/or the processors 515) one or more processes described herein.

In some embodiments, the interface 525 may include at least one of network communication devices, network interfaces, and/or other possible communication interfaces. The interface 525 may include wired or wireless communications interfaces (e.g., jacks, antennas, transmitters, receivers, transceivers, wire terminals, etc.) for conducting data communications with various systems, devices, and/or components described herein. The interface 525 may be direct (e.g., local wired or wireless communications) and/or via a communications network. For example, the interface 525 may include an Ethernet card and port for sending and receiving data via an Ethernet-based communications link or network. The interface 525 may also include a Wi-Fi transceiver for communicating via a wireless communications network. The interface 525 may include a power line communications interface. The interface 525 may include an Ethernet interface, a USB interface, a serial communications interface, and/or a parallel communications interface.

In some embodiments, the processing circuit 510 may receive at least one input. For example, the processing circuits 510 may receive input signals from the I/O devices 535. To continue this example, the processing circuits 510 may receive the input signals responsive to interactions with the I/O devices 535. In some embodiments, the interactions with the I/O devices 535 may refer to and/or include an operator of the vehicle interfacing with, engaging, and/or otherwise moving the I/O devices 535. For example, the processing circuits 510 may receive a first input signal, from the I/O devices 535, responsive to an operator of the vehicle 10 moving the I/O devices 535 in a given direction. As another example, the processing circuits 510 may receive a second input, from the I/O devices 535, responsive to an operator of the vehicle 10 selecting an icon displayed on a user interface.

In some embodiments, the input signals may include and/or indicate a request for one or more amounts of fluid power. For example, a first input signal may include a given voltage level and/or current level to indicate a given amount of fluid power for the hydraulic system 545 to provide. Stated otherwise, the processing circuit 510 may receive input signals that include a request for a given amount of fluid power. In some embodiments, interactions with the I/O devices 535 may cause the I/O devices 535 to transmit, to the processing circuit 510, input signals having levels that correspond to the interactions. For example, movement of the joystick (e.g., the I/O device 535) at a given speed may cause the I/O device 535 to transmit an input signal that corresponds to the given speed such that a given amount of fluid power is provided by the hydraulic system 545. Stated otherwise, the movement of the joystick at the given speed may cause a given element 540 to move at a proportional rate.

In some embodiments, the processing circuits 510 may obtain information that corresponds to the vehicle 10. For example, the processing circuits 510 may obtain information collected by the sensors 530. In some embodiments, the information may indicate various metrics of the vehicle 10. For example, the information may indicate a status of an energy source (e.g., the engine 20, one or more batteries, etc.) for the hydraulic system 545. The status of the energy source may include information such as rotations per minute (RPM), oil pressure, State of Charge, discharge rates, etc. As another example, the information may indicate a metric, such as a speed of the vehicle 10. As even another example, the information may indicate a metric, such as an output (e.g., fluid rate, fluid flow, etc.) of the hydraulic system 545. In some embodiments, the processing circuit 510 may monitor and/or determine statuses of the elements 540. For example, the processing circuit 510 may monitor movement of the elements 540 to determine when the elements are idle (e.g., a given status) and/or active (e.g., a second given status).

In some embodiments, the processing circuit 510 may determine that one or more amounts of fluid power exceed a threshold. For example, the processing circuit 510 may determine that a given input signal includes and/or indicates a request for an amount of fluid power that exceeds a power threshold (e.g., a power output) of the hydraulic system 545. As another example, the processing circuit 510 may determine that a requested amount of fluid power (as indicated by one or more input signals) would exceed a maximum amount of fluid power that the hydraulic system 545 can provide. Stated otherwise, the hydraulic system 545 is unable to provide the requested amount of fluid power.

In some embodiments, the processing circuit 510 may determine that the amounts of fluid power exceed the power threshold based on information obtained from the sensors 530 and/or based on a status of an element 540. For example, the processing circuit 510 may determine that a requested amount of fluid power exceeds a threshold for the hydraulic system 545 based on an output (e.g., amount of fluid power) of the hydraulic system 545 and based on a given element 540 moving (e.g., a status). Stated otherwise, the processing circuit 510 may determine that a requested amount of fluid power, based on the status of the hydraulic system 545 and/or based on the status of one or more elements 540, would exceed a maximum output of the hydraulic system 545.

In some embodiments, the processing circuit 510 may modify at least one input. For example, the processing circuits 510 may modify the input signals provided by the I/O devices 535. As another example, the processing circuits 510 may modify an input signal by adjusting the input signal from a first level (e.g., a first voltage level, a first current level etc.) to a second level (e.g., a second voltage level, a second current level, etc.). As another example, the processing circuits 510 may modify an input signal by producing a subsequent signal to replace or supplement the input signal. Stated otherwise, the input signal is modified by the transmission of a subsequent signal or different signal that includes a signal strength or signal level different than the signal strength or signal level of the input signal.

In some embodiments, the processing circuit 510 may modify the input signals responsive to determining that one or more requested amounts of fluid power exceed a threshold. For example, a first input signal may request, based on a given level of the first input signal, a given amount of fluid power. To continue this example, the processing circuit 510 may determine that the given amount of fluid power exceeds a threshold for the hydraulic system 545. In this example, the processing circuit 510 may modify the input signal to change the input signal from the given level to a second given level.

In some embodiments, the processing circuit 510 may modify the input signals to adjust the inputs signals to levels associated with one or more amounts of fluid power that are at and/or below the threshold of the hydraulic system 545. For example, the hydraulic system 545 may have a maximum output (e.g., maximum fluid power) and based on current output of the hydraulic system 545, the hydraulic system 545 may be operating at 70% of its maximum output. To continue this example, the processing circuit 510 may modify a first input signal (based on a first level of the first input signal requesting an amount of fluid power that exceeds 30% of the maximum output) to a second level that is associated with less than 30% of the maximum output of the hydraulic system 545. Stated otherwise, the first input signal is modified (by the processing circuit 510) to a signal strength or signal level that represents an amount of fluid power which would not result in exceeding the maximum fluid power of the hydraulic system 545.

In some embodiments, the processing circuit 510 may transmit the input signals to the hydraulic system 545. For example, the processing circuit 510 may forward the input signals, received from the I/O devices 535, to the hydraulic system 545. As another example, the processing circuit 510 may serve as a gateway between the I/O devices 535 and the hydraulic system 545. In some embodiments, the processing circuit 510 may transmit the input signals responsive to modification of the input signals. For example, the processing circuits 510 may transmit a first signal responsive to reducing the first signal from a first level to a second level.

In some embodiments, the processing circuit 510 may transmit the input signals to cause the hydraulic system 545 to provide fluid power. For example, the processing circuit 510 may transmit a first input signal to cause the hydraulic system 545 to provide a given amount of fluid power to a given element 540 to cause the given element 540 to perform an operation. In some embodiments, the processing circuit 510 may transmit input signals to cause the hydraulic system 545 to provide given amounts of fluid power. For example, the processing circuit 510 may modify an input signal from a first level to a second level. To continue this example, the processing circuit 510 may transmit the input signal, having the second level, to cause the hydraulic system 545 to provide an amount of fluid power that corresponds to the second level.

In some embodiments, the elements 540 may include at least one priority level. For example, the elements 540 may include a first priority level and/or a second priority level. In some embodiments, the elements 540 may have a priority level based on an operation performed by the elements 540. For example, a first element 540 may have a first priority level based on a first operation performed by the first element 540. As another example, a second element 540 may have a second priority level based on a second operation performed by the second element 540.

In some embodiments, the processing circuit 510 may modify one or more input signals based on a priority level of the elements 540. For example, the processing circuit 510 may modify a first input signal from a first level to a second level to cause the hydraulic system 545 to provide a given amount of fluid power (e.g., a value). To continue this example, the processing circuit 510 may modify the first input signal based on a priority level of a given element 540 set to receive or associated with the given amount of fluid power. Stated otherwise, the processing circuit 510 may cause the hydraulic system 545, by modifying the input signals, to provide a given amount or value of fluid power based on a priority level of the element 540 set to receive the fluid power.

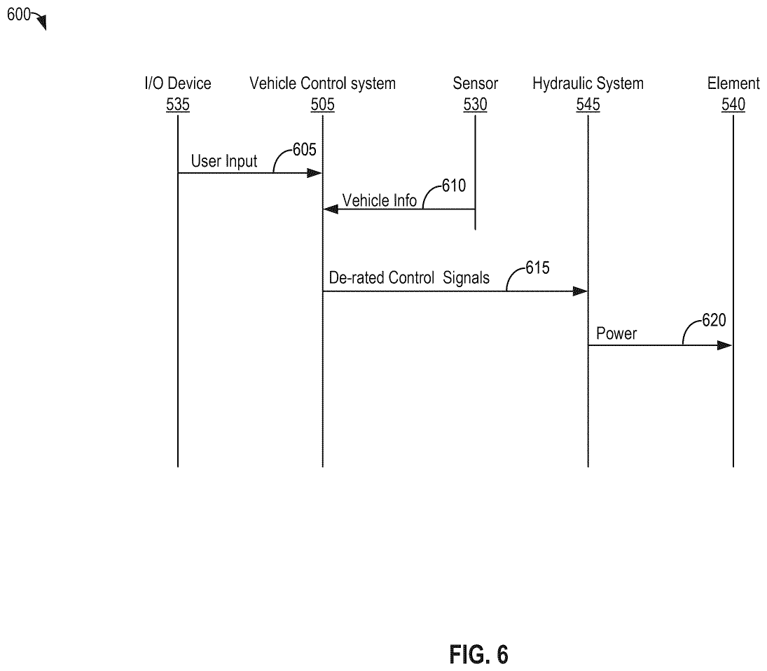

FIG. 6 depicts a sequence diagram 600, according to an exemplary embodiment. In some embodiments, the sequence diagram 600 may represent and/or illustrate communication between one or more systems, components, and/or devices of the system 500. For example, the sequence diagram 600 may represent communication between the vehicle control system 505 and the I/O devices 535. In some embodiments, at least one step of the sequence diagram 600 may be altered, replicated, repeated, reproduced, removed, modified, separated, and/or otherwise changed.

In some embodiments, at step 605, the vehicle control system 505 may receive at least one user input. For example, the processing circuits 510 may receive the user input, via the I/O device 535, responsive to an interaction with the I/O device 535. In some embodiments, the user input may refer to and/or include at least one input signal. For example, the user input may cause the I/O device 535 to transmit an input signal to the vehicle control system 505. As another example, the user input may refer to or represent an input signal associated with a request for a given amount of fluid power. As another example, the vehicle control system 505 may receive one or more vocational inputs (e.g., audible inputs, spoken inputs, etc.) that pertain to control or operation of one or more of the elements 540. Stated otherwise, the vehicle control system 505 may receive one or more inputs without a corresponding interaction with the I/O device 535.

In some embodiments, at step 610, the vehicle control system 505 may receive vehicle information. For example, the processing circuits 510 may receive vehicle information collected by the sensors 530 (e.g., metrics of an energy source, vehicle speed, telematics, etc.). As another example, the processing circuit 510 may receive information to indicate various operations of the vehicle 10 (e.g., statuses of the elements 540).

In some embodiments, the vehicle information may include and/or indicate a current output and/or workload of the hydraulic system 545 (e.g., how much fluid power the hydraulic system 545 is providing). In other embodiments, the vehicle information may include and/or indicate current statuses of the elements 540 (e.g., which elements 540 are active and/or idle). In some embodiments, the processing circuit 510 may determine, based on the user input received in step 605 and the vehicle information received in step 610, that a requested amount of fluid power indicated (as indicated or requested by the user input in step 605) would exceed an output of the hydraulic system 545. The processing circuit 510 may modify the input signal to adjust (e.g., de-rate, reduce, alter, modify, decrease, etc.) the input signal from a first level to a second level to change an amount of fluid power associated with the input signal (e.g., a requested amount of fluid power). Stated otherwise, the processing circuit 510 may modify the input signal to a signal strength or signal level associated with a reduced amount of fluid power relative to the original amount of requested fluid power.

In some embodiments, at step 615, the vehicle control system 505 may transmit at least one de-rated control signal. For example, the vehicle control system 505 may transmit the input signal having the second level to the hydraulic system 545. As another example, the vehicle control system 505 may transmit an input signal, to the hydraulic system 545, that was adjusted to indicate a request for a given amount of fluid power from the hydraulic system 545.

In some embodiments, at step 620, the hydraulic system 545 may provide power. For example, the hydraulic system 545 may provide fluid power to the elements 540 based on the input signals (e.g., de-rated control signals, modified input signals, etc.) received in step 615. As another example, the hydraulic system 545 may provide fluid power based on the input signals provided by the I/O device 535 to the vehicle control system 505. In some embodiments, the hydraulic system 545 may provide fluid power to the elements 540 to cause the elements 540 to perform one or more operations. For example, the hydraulic system 545 may provide fluid power to an actuator (e.g., an element 540) to cause the actuator to extend, retract, rotate, spin, and/or otherwise move responsive to receipt of the fluid power from the hydraulic system 545.

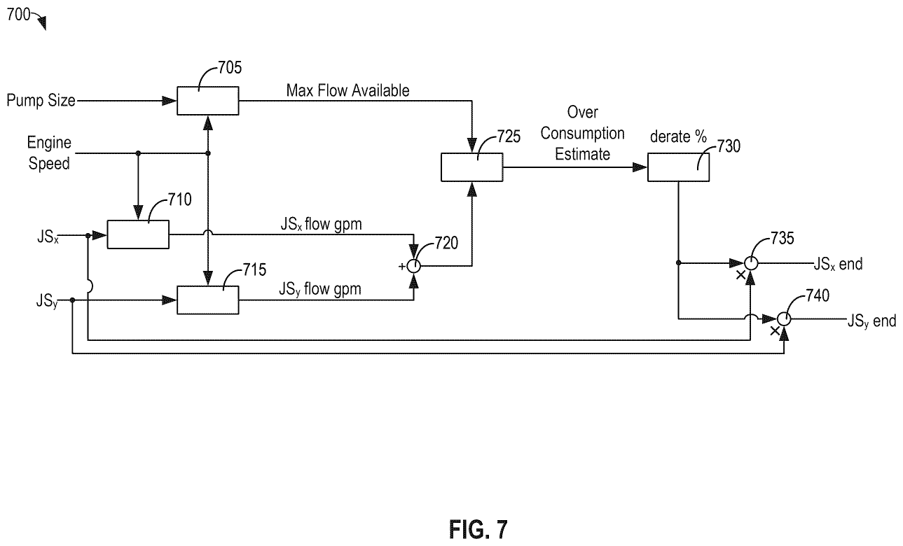

FIG. 7 depicts a block diagram of a logic path 700, according to an exemplary embodiment. In some embodiments, the logic path 700 may include various control paths performed and/or evaluated by the vehicle control system 505. For example, the vehicle control system 505 may perform logic analysis to evaluate the input signals provided by the I/O device 535. In some embodiments, the logic path 700 may include at least one logic block. For example, the logic path 700 may include a first logic block and a second logic block.

In some embodiments, at logic block 705, the vehicle control system 505 may receive information to indicate a pump size for the hydraulic system 545. For example, the vehicle control system 505 may receive an indication that the hydraulic system 545 is able to provide a flow rate of 15 gallons per minute (GPM) based on a pump size. In some embodiments, the vehicle control system 505 may determine a max flow rate of the hydraulic system 545 based on the information received at logic block 705.

In some embodiments, at logic block 710, the vehicle control system 505 may receive an input signal associated with a first element 540. For example, the vehicle control system 505 may receive an input signal, from the I/O device 535, responsive to a first interaction with the I/O device 535. In some embodiments, the input signal, received at logic block 710, may indicate a request for a given amount of fluid power. For example, based on the interaction with the I/O device 535, the I/O device 535 may transmit an input signal having a given level to indicate the given amount of fluid power.

In some embodiments, at logic block 710, the vehicle control system 505 may combine, converge, conflate, and/or aggregate the information received at logic block 705, information associated with the vehicle 10 (e.g., engine speed, oil pressure, RPMs, etc.), and the input signal received at logic block 710. For example, the vehicle control system 505 may perform one or more operations based on the combination of information.

In some embodiments, at logic block 715, the vehicle control system 505 may receive an input signal associated with a second element 540. For example, the vehicle control system 505 may receive a second input signal, form the I/O device 535, responsive to a second interaction with the I/O device 535. In some embodiments, the vehicle control system 505 may receive the second input signal, at logic block 715, prior to, subsequent to, and/or simultaneously to receiving the input signal at logic block 710. For example, the vehicle control system 505 may receive the second input signal prior to receiving the first input signal. To continue this example, the vehicle control system 505 may forward the input signal, to the hydraulic system 545, to cause the hydraulic system 545 to provide an amount of fluid power, based on the second input signal, to the second element 540 to cause the second element to perform an operation.

In some embodiments, at logic block 720, the vehicle control system 505 may combine, concatenate, aggregate, and/or otherwise sum the amounts of fluid power requested by the first input signal, received at logic block 710, and the second input signal, received at logic block 715, to determine a total amount of fluid power requested. For example, the first input signal may indicate a request for 5 GPM of fluid power and the second input signal may indicate a request for 8 GPM. To continue this example, the vehicle control system 505 can determine that the total requested amount of fluid power is 13 GPM.

In some embodiments, at logic block 725, the vehicle control system 505 can compare the max flow rate of the hydraulic system 545 (as determined at logic block 705) with the total requested amount of fluid power, as determined at logic block 720. For example, the vehicle control system 505 can determine that the total requested amount of fluid power is less than, equal to, and/or greater than the max flow rate of the hydraulic system 545. In some embodiments, the vehicle control system 505 can forward and/or transmit the first input signal and the second input signal to the hydraulic system 545 to cause the hydraulic system 545 to provide fluid power to the first element 540 and the second element 540 based on the requested amounts of fluid power, as indicated by the first input signal and the second input signal.

In some embodiments, at logic block 730, the vehicle control system 505 may de-rate (e.g., modify) the first input signal and/or the second input signal responsive to a determination that the total requested amount of fluid power exceeds the max flow rate (e.g., a threshold) of the hydraulic system 545. For example, the vehicle control system 505 may modify the first input signal from a first level to a second level. To continue this example, the first level may indicate a request for 6 GPM (e.g., an amount of fluid power) from the hydraulic system 545. In this example, the vehicle control system 505 may modify the first input signal from the first level to the second level by a given percentage (e.g., 5%, 10%, 18%, 22%, etc.). As another example, the vehicle control system 505 may modify the second input signal from a first level to a second level by a similar amount and/or percentage to that of the first input signal. Stated otherwise, the first input signal and the second input signal may be proportionally de-rated to one another.

In some embodiments, at logic block 730, the vehicle control system 505 may determine a percentage or an amount for which to de-rate or modify one or more signals. For example, the vehicle control system 505 may determine that input signals (from logic block 710 and logic block 715) be de-rated or reduced by 15%. To continue this example, the vehicle control system 505 may de-rate the input signals such that a corresponding amount of fluid power is less than the max flow of the vehicle 10. Stated otherwise, the vehicle control system 505 may de-rate the input signal such that the requested amount of fluid power is less than a threshold.

In some embodiments, at logic block 735, the vehicle control system 505 may transmit and/or forward the first input signal, modified using the de-rate amount or percentage from logic block 730, to the hydraulic system 545 to cause the hydraulic system 545 to provide fluid power to the first element 540 in accordance with the second level of the first input signal. In some embodiments, at logic block 740, the vehicle control system 505 may transmit and/or forward the second input signal, modified using the de-rate amount or percentage from logic block 730, to the hydraulic system 545 to cause the hydraulic system 545 to provide fluid power to the second element 540 in accordance with the second level of the second input signal.

While some of the logic blocks described herein have referred to and/or included examples of multiple elements 540 having been active, this is for illustrative purposes only and is in no way limiting. For example, the logic path 700 may be performed based on only a single element 540 being active. As another example, the logic path 700 may be performed based on eight elements 540 being active.

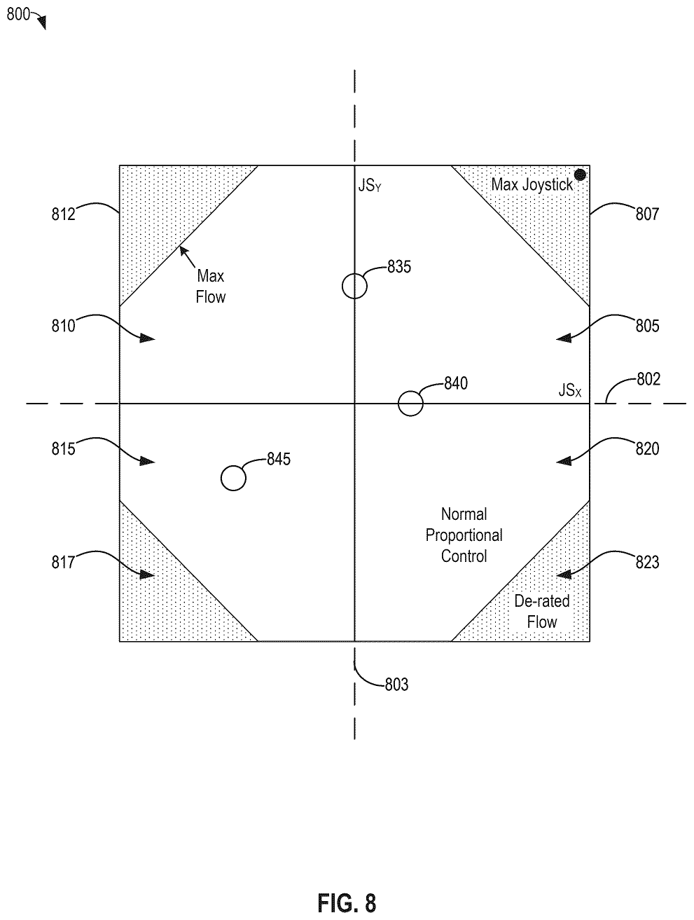

FIG. 8 includes an illustration of a graph 800, according to an exemplary embodiment. In some embodiments, the graph 800 may represent various movements and/or movement combinations that an operator may perform with the I/O devices 535. For example, the graph 800 may represent interactions that an operator may perform with a joystick. In some embodiments, the graph 800 may include at least one quadrant. For example, in FIG. 8, the graph is shown to include a quadrant 805, a quadrant 810, a quadrant 815, and a quadrant 820.

In some embodiments, the quadrants may represent and/or refer to given operations of the elements 540. For example, the quadrant 805 may refer to and/or include one or more first operations (e.g., placement and/or location of the I/O device 535 within the quadrant 805 may cause the elements 540 to perform the first operations). As another example, the quadrant 810 may refer to and/or include one or more second operations.

In some embodiments, the quadrants may define and/or establish at least one axis. For example, as shown in FIG. 8, the quadrants (e.g., the quadrant 805, the quadrant 810, the quadrant 815, and the quadrant 820) define a first axis 802 and a second axis 803. The first axis 802 may refer to and/or include a horizontal axis. The second axis 803 may refer to and/or include a vertical axis. In some embodiments, the first axis 802 and/or the second axis 803 may be associated with a given element 540. For example, the first axis 802 may be associated with the arms 34 (e.g., a first element 540) and the second axis 803 may be associated with the grabber 52 (e.g., a second element 540).

In some embodiments, movement along only the first axis 802 or the second axis 803 may cause the first element 540 or the second element 540 to perform an operation. For example, node 835 represents a movement of the I/O device 535 along only the second axis 803 and as such would result in only an action of the second element 540. As another example, node 840 represents a movement of the I/O device 535 along only the first axis 802 and as such would result in only an action of the first element 540. As another example, node 845 represents a movement of the I/O device in both the first axis 802 and the second axis 803 and as such would result in action of the first element 540 and the second element 540.

In some embodiments, the graph 800 may include at least one corner. For example, as shown in FIG. 8, the graph 800 includes corner 807, corner 812, corner 817, and corner 823. In some embodiments, the corners may represent and/or refer to movements of the I/O device 535 that correspond to requested amounts of fluid power that exceed the max flow rate of the hydraulic system 545. For example, movement of the I/O device 535 that would cause the I/O device 535 to move into the corner 812 would result in the vehicle control system 505 receiving input signals that indicate a request for an amount of fluid power that exceeds the max flow rate of the hydraulic system 545. In some embodiments, the portions of the graph 800 that are separate from the corners may refer to and/or correspond to various amounts of fluid power that do not exceed a max flow rate of the hydraulic system 545.

In some embodiments, the vehicle control system 505 may receive one or more input signals responsive to movement of the I/O device 535 relative to the graph 800. For example, movement of the I/O device 535 from a center point of the graph (e.g., a resting point of the I/O device 535) to the node 845 may cause the vehicle control system 505 to receive an input to control a first element 540 and a second element 540. In some embodiments, the input signals may indicate requested amounts of fluid power. For example, movement of the I/O device 535 to the node 845 may be associated with providing a first amount of fluid power to the first element 540 and providing a second amount of fluid power to the second element 540.

In some embodiments, the vehicle control system 505 may determine that the input signals indicate a request for an amount of fluid power that exceeds the max flow rate of the hydraulic system 545. For example, the vehicle control system 505 may determine that the I/O device 535 was moved into the corner 812. To continue this example, the vehicle control system 505 may determine that the amounts of fluid power associated with the interaction (e.g., movement of the I/O device 535) exceed the max flow rate for the hydraulic system 545.

In some embodiments, the vehicle control system 505 may modify the input signals responsive to a determine that a combination of the amounts of fluid power exceed a threshold. For example, the vehicle control system 505 may modify input signals, transmitted by the I/O device 535 responsive to movement of the I/O device 535 to the corner 823, to adjust the amounts of fluid power. To continue this example, the vehicle control system 505 may adjust a first input signal from a first level to a second level to adjust an amount of fluid power requested for a first element 540. In this example, the vehicle control system 505 may adjust a second input signal from a first level to a second level to adjust an amount of fluid power requested for a second element 540. In some embodiments, the adjustment (e.g., a reduction, modification, alteration, etc.) of the first input signal and the second input signal may be proportion (e.g., the first input signal and the second input signal are modified by the same amount and/or the same percentage).

In some embodiments, the elements 540 may receive various amounts of fluid power. For example, a first element 540 may receive a given amount of fluid power to move at a given speed and/or rate. To continue this example, the first element 540 may receive a second given amount of fluid power to move at a second given speed and/or rate. In some embodiments, the hydraulic system 545 may provide a given amount of fluid power to the elements 540. The elements 540 may receive given portions of the fluid power provided by the hydraulic system 545. For example, a first element 540 may receive a first portion of the fluid power and a second element 540 may receive a second portion of the fluid power.

As an example, the hydraulic system 545 may provide 15 GPM (e.g., a max flow rate) and the first element 540 and the second element 540 may consume (e.g., receive) up to 10 GPM. To continue this example, operation of both the first element 540 and the second element 540 at 10 GPM each would exceed the max flow rate of the hydraulic system 545. In this example, the vehicle control system 505 may modify a first input signal associated with operation of the first element 540 to cause a max requested amount of fluid power to be 7.5 GPM and may modify a second input signal associated with operation of the second element 540 to cause a max requested amount of fluid power to be 7.5 GPM.

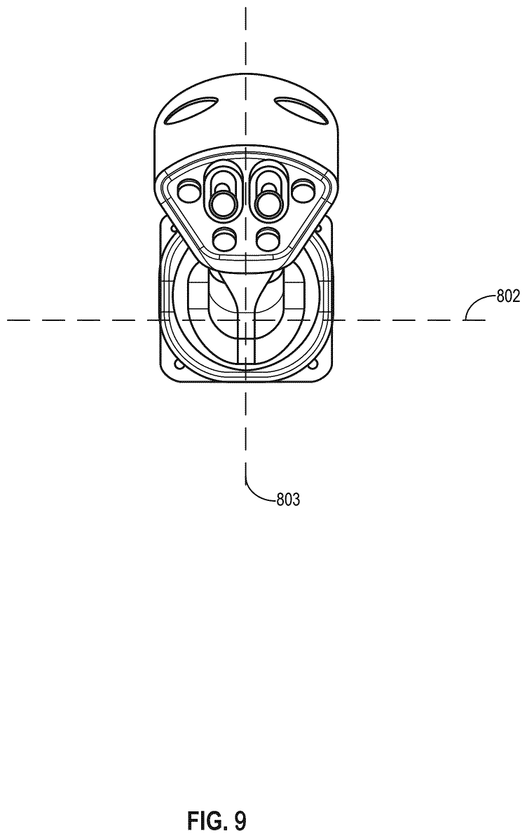

FIG. 9 is a perspective view of a joystick (e.g., the I/O device 535), according to an exemplary embodiment. As shown in FIG. 9, the first axis 802 and the second axis 803 have been superimposed on the I/O device 535 for illustrative purposes only. In some embodiments, movement of the joystick relative to the first axis 802 and/or the second axis 803 may cause the I/O device 535 to transmit one or more input signals to the vehicle control system 505. For example, movement of the joystick along the first axis 802 may cause the I/O device 535 to transmit a first input signal to the vehicle control system 505. To continue this example, the I/O device 535 may transmit the first input signal with a given level in accordance with the movement of the joystick. Stated otherwise, the given level of the first input signal may be based on the movement of the joystick. As another example, a signal strength (e.g., voltage level, current level, power level, etc.) of one or more signals (which result from movement of the joystick) may be based on a displacement or change in position of the joystick with respect to the origin of the first axis 802 and the second axis 803.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle 10 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A refuse vehicle, comprising:
a first element configured to perform a first operation of the refuse vehicle;
a second element configured to perform a second operation of the refuse vehicle;
a hydraulic system configured to power the first element and the second element;
a device configured to receive inputs to control operation of the first element and the second element; and
a control system in communication with the hydraulic system and the device, the control system comprising one or more memory devices storing instructions thereon that, when executed by one or more processors, cause the one or more processors to:
receive, responsive to a first interaction with the device, a first input to control the first element to cause the first element to perform the first operation of the refuse vehicle, the first input to indicate a request for a first amount of fluid power from the hydraulic system;
obtain, via one or more sensors of the refuse vehicle, information to indicate a metric associated with an energy source of the hydraulic system;
determine, based on the information and a status of the second element, that the first amount of fluid power exceeds a fluid power threshold for the hydraulic system;
modify, responsive to determination that the first amount of fluid power exceeds the fluid power threshold, the first input by decreasing a power level associated with the first input from a first level to a second level to reduce the request from the first amount of fluid power to a second amount of fluid power below the fluid power threshold; and
transmit, to the hydraulic system, one or more signals having the second level of the power level to cause the hydraulic system to provide the second amount of fluid power to the first element.

2. The refuse vehicle of claim 1, wherein the status of the second element includes the second element performing the second operation based on a second input, and wherein the instructions further cause the one or more processors to:
receive, responsive to a second interaction with the device, the second input to control the second element, the second interaction received prior to the first interaction, the second input associated with a second request for a third amount of fluid power from the hydraulic system;
cause the hydraulic system to provide the third amount of fluid power to the second element;
modify, responsive to determination that the first amount of fluid power exceeds the fluid power threshold, the second input to reduce the second request from the third amount of fluid power to a fourth amount of fluid power; and
cause, responsive to modification of the second input, the hydraulic system to provide the fourth amount of fluid power to the second element;
wherein a reduction from the first amount of fluid power to the second amount of fluid power is proportional to a reduction from the third amount of fluid power to the fourth amount of fluid power.

3. The refuse vehicle of claim 1, wherein the instructions further cause the one or more processors to:
receive, responsive to a second interaction with the device, a second input to control the first element and the second element, the second input associated with a second request to provide a third amount of fluid power to the first element and a fourth amount of fluid power to the second element; and
modify, responsive to a determination that a combination of the third amount of fluid power and the fourth amount of fluid power exceeds the fluid power threshold, the second input to reduce the second request from (i) the third amount of fluid power to a fifth amount of fluid power and (ii) the fourth amount of fluid power to a sixth amount of fluid power;
wherein a reduction from the third amount of fluid power to the fifth amount of fluid power is proportional to a reduction from the fourth amount of fluid power to the sixth amount of fluid power.

4. The refuse vehicle of claim 1, wherein the second amount of fluid power includes a first value and a second value, wherein the instructions further cause the one or more processors to:
cause the hydraulic system to provide the first value of the second amount of fluid power based on the first element having a first priority level; and
cause the hydraulic system to provide the second value of the second amount of fluid power based on the first element having a second priority level.

5. The refuse vehicle of claim 1, further comprising:
the hydraulic system configured to provide a given amount of fluid power to the first element and the second element;
the first element configured to receive a first portion of the given amount of fluid power; and
the second element configured to receive a second portion of the given amount of fluid power;
wherein the instructions further cause the one or more processors to:
adjust fluid power provided to the first element and the second element based on a proportion between the first portion and the second portion.

6. The refuse vehicle of claim 1, wherein the instructions further cause the one or more processors to:
control the hydraulic system to provide the second amount of fluid power to the first element to cause the first element to perform the first operation of the refuse vehicle in accordance with the second amount of fluid power.

7. The refuse vehicle of claim 1, wherein the first level of the power level includes a first voltage level to indicate the first amount of fluid power, wherein second level of the power level includes a second voltage level to indicate the second amount of fluid power, and wherein the instructions further cause the one or more processors to:
transmit the one or more signals having the second voltage level to indicate the second amount of fluid power.

8. The refuse vehicle of claim 1, wherein the first element is a lifting apparatus, wherein the second element is a retracting apparatus, and wherein the device is a joystick.

9. The refuse vehicle of claim 1, wherein the energy source includes at least one of an engine or one or more batteries.

10. A system, comprising:
one or more memory devices storing instructions thereon that, when executed by one or more processors, cause the one or more processors to:
receive, responsive to a first interaction with a device of a refuse vehicle, a first input to control a first element of the refuse vehicle to cause the first element to perform a first operation of the refuse vehicle, the first input to indicate a request for a first amount of fluid power from a hydraulic system of the refuse vehicle;
obtain, via one or more sensors of the refuse vehicle, information to indicate a metric associated with an energy source of the hydraulic system;
determine, based on the information and a status of a second element of the refuse vehicle, that the first amount of fluid power exceeds a fluid power threshold for the hydraulic system; and
modify the first input to adjust a power level of the first input from a first level to a second level to reduce the request from the first amount of fluid power to a second amount of fluid power.

11. The system of claim 10, wherein the instructions further cause the one or more processors to:
adjust the first input by decreasing the power level of the first input from the first level to the second level, the first level associated with the first amount of fluid power, and the second level associated with the second amount of fluid power; and
transmit, to the hydraulic system, one or more signals having the second level of the power level to cause the hydraulic system to provide the second amount of fluid power to the first element.

12. The system of claim 10, wherein the status of the second element includes the second element performing a second operation based on a second input, and wherein the instructions further cause the one or more processors to:
receive, responsive to a second interaction with the device, the second input to control the second element, the second interaction received prior to the first interaction, the second input associated with a second request for a third amount of fluid power from the hydraulic system;
cause the hydraulic system to provide the third amount of fluid power to the second element;
modify, responsive to determination that the first amount of fluid power exceeds the fluid power threshold, the second input to reduce the second request from the third amount of fluid power to a fourth amount of fluid power; and
cause, responsive to modification of the second input, the hydraulic system to provide the fourth amount of fluid power to the second element;
wherein a reduction from the first amount of fluid power to the second amount of fluid power is proportional to a reduction from the third amount of fluid power to the fourth amount of fluid power.

13. The system of claim 10, wherein the instructions further cause the one or more processors to:
receive, responsive to a second interaction with the device, a second input to control the first element and the second element, the second input associated with a second request to provide a third amount of fluid power to the first element and a fourth amount of fluid power to the second element; and
modify, responsive to a determination that a combination of the third amount of fluid power and the fourth amount of fluid power exceed the fluid power threshold, the second input to reduce the second request from (i) the third amount of fluid power to a fifth amount of fluid power and (ii) the fourth amount of fluid power to a sixth amount of fluid power;
wherein a reduction from the third amount of fluid power to the fifth amount of fluid power is proportional to a reduction from the fourth amount of fluid power to the sixth amount of fluid power.

14. The system of claim 10, wherein the second amount of fluid power includes a first value and a second value, wherein the instructions further cause the one or more processors to:
cause the hydraulic system to provide the first value of the second amount of fluid power based on the first element having a first priority level; and
cause the hydraulic system to provide the second value of the second amount of fluid power based on the first element having a second priority level.

15. The system of claim 10, further comprising:
the hydraulic system configured to provide a given amount of fluid power to the first element and the second element;
the first element configured to receive a first portion of the given amount of fluid power; and
the second element configured to receive a second portion of the given amount of fluid power;
wherein the instructions further cause the one or more processors to:
adjust fluid power provided to the first element and the second element based on a proportion between the first portion and the second portion.

16. The system of claim 10, wherein the instructions further cause the one or more processors to:
control the hydraulic system to provide the second amount of fluid power to the first element to cause the first element to perform the first operation of the refuse vehicle in accordance with the second amount of fluid power.

17. The system of claim 10, wherein the first input includes a first voltage level to indicate the first amount of fluid power, and wherein modification of the first input includes the one or more processors to:
forward, to the hydraulic system, a signal having a second voltage level to indicate the second amount of fluid power; and
cause, based on the signal, the hydraulic system to provide the second amount of fluid power.

18. A refuse vehicle, comprising:
at least one element configured to perform one or more operations of the refuse vehicle;
a power system configured to provide power to the at least one element;
a device configured to receive inputs to control operation of the at least one element; and
one or more processing circuits, configured to:
receive, responsive to a first interaction with the device, a first input to control the at least one element, the first input to indicate a request for a first amount of power from the power system;
determine that the first amount of power exceeds a power threshold for the power system; and
modify, responsive to determination that the first amount of power exceeds the power threshold, the first input to reduce the request from the first amount of power to a second amount of power below.

19. The refuse vehicle of claim 18, wherein the one or more processing circuits are further configured to:
modify the first input by decreasing a power level associated with the first input from a first level to a second level, the first level associated with the first amount of power, and the second level associated with the second amount of power; and
transmit, to the power system, one or more signals having the second level of the power level to cause the power system to provide the second amount of power to the at least one element.

20. The refuse vehicle of claim 18, wherein the first input includes a first voltage level to indicate the first amount of power, and wherein modification of the first input includes the one or more processing circuits to:
forward, to the power system, a signal having a second voltage level to indicate the second amount of power; and
cause, based on the signal, the power system to provide the second amount of power.
